(19) United States
(12) Patent Application Publication
(10) Pub. No.: US 2009/0248722 A1
(43) Pub. Date: Oct. 1, 2009

(54) CLUSTERING ANALYTIC FUNCTIONS

(75) Inventors: Alexander Pikovsky, Lexington, MA (US); David Joel Pennell, SR., Dripping Springs, TX (US); Robert Joseph McKeown, North Reading, MA (US); Stephen Pair, Roswell, GA (US); Monty Kamath, Hudson, OH (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/056,890

(22) Filed: Mar. 27, 2008

(51) Int. Cl. G06F 17/30

(52) U.S. Cl. 707/101; 707/E17.009

(57) ABSTRACT

A method, system, and computer usable program product for clustering analytic functions are provided in the illustrative embodiments. Information about a set of analytic function instances is received. Information about a set of time series is received. A subset of time series may be a set of input time series to an analytic function instance in the set of analytic function instances. An analytics clustering rule is applied to the information about the set of analytic function instances and the information about the set of time series. A subset of time series is clustered as a group in response to applying the analytics clustering rule. An analytics clustering rule may determine whether all time series in the set of input time series to an analytic function instance are members of a group, and group an output time series of the analytic function instance in the group if all time series in the set of input time series are members of the group.

### RELATED APPLICATION

The present invention is related to similar subject matter of co-pending and commonly assigned U.S. patent application Ser. No. ______ (Attorney Docket No. AUS920080222US1) entitled “DEPLOYING ANALYTIC FUNCTIONS,” filed on ______, 2008, and U.S. patent application Ser. No. ______ (Attorney Docket No. AUS920080223US1) entitled “SELECTIVE RE-COMPUTATION USING ANALYTIC FUNCTIONS,” filed on ______, 2008, which are hereby incorporated by reference.

### BACKGROUND OF THE INVENTION

1. Field of the Invention

The present invention relates generally to an improved data processing system, and in particular, to a computer implemented method for performing data analysis. Still more particularly, the present invention relates to a computer implemented method, system, and computer usable program code for clustering analytic functions.

2. Description of the Related Art

Present data processing environments include a collection of hardware, software, firmware, and communication pathways. The hardware elements can be of a vast variety, such as computers, other data processing systems, data storage devices, routers, switches, and other networking devices, to give some examples. Software elements may be software applications, components of those applications, copies, or instances of those applications or components.

Firmware elements may include a combination of hardware elements and software elements, such as a networking device with embedded software, a circuit with software code stored within the circuit. Communication pathways may include a variety of interconnections to facilitate communication among the hardware, software, or firmware elements. For example, a data processing environment may include a combination of optical fiber, wired or wireless communication links to facilitate data communication within and outside the data processing environment.

Management, administration, operation, repair, expansion, or replacement of elements in a data processing environment relies on data collected at various points in the data processing environment. For example, a management system may be a part of a data processing environment and may collect performance information about various elements of the data processing environment over a period. As another example, a management system may collect information in order to troubleshoot a problem with an element of the data processing environment. As another example, a management system may collect information to analyze whether an element of the data processing environment is operating according to an agreement, such as a service level agreement.

Furthermore, the various elements of a data processing environment often have components of their own. For example, a router in a network may have many interfaces to which many data processing systems may be connected. A software application may have many components, such as web services and instances thereof, that may be distributed across a network. A communication pathway between two data processing systems may have many links passing through many routers and switches.

Management systems may collect data at or about the various components as well in order to gain insight into the operation, control, performance, troubles, and many other aspects of the data processing environment. Each element or component can be a source of data that is usable in this manner. The number of data sources in some data processing environments can be in the thousands or millions, to give a sense of scale.

Furthermore, not only is the data collected from a vast number of data sources, a variety of data analyses has to be performed on a combination of such data. A software component, a data processing system, or another element of the data processing environment may perform a particular analysis. In some data processing environments, such as the examples provided above for scale, the number of analyses can range in the millions.

Additionally, a particular analysis may be relevant to a particular part of the data processing environment, or use data sources situated in a particular set of data processing environment elements. Consequently, the various elements and components in the data processing environment performing the millions of analyses may be scattered across the data processing environment, communicating and interacting with each other to provide the management insight.

### SUMMARY OF THE INVENTION

The illustrative embodiments provide a method, system, and computer usable program product for clustering analytics functions. Information about a set of analytic function instances is received. Information about a set of time series is received. The set of time series may include data produced by a set of physical components in an environment. A subset of the set of time series may be a set of input time series received over a data network in an analytic function instance in the set of analytic function instances. An analytics clustering rule is applied to the information about the set of analytic function instances and the information about the set of time series. A subset of time series is clustered as a group in response to applying the analytics clustering rule.

Receiving the information about the set of analytic function instances includes receiving information about an input binding of the analytic function instance, receiving information about a temporal semantics of the analytic function instance, and receiving information about an output time series of the analytic function instance. Receiving the information about the set of time series includes receiving information about a source of a time series in the set of time series, the information about the source including information about a location of the source, and receiving information about a periodicity or a delay of the time series in the set of time series, or both. An output time series of the analytic function instance may be a time series in the set of time series. A dependency between a two analytic function instances in the set of analytic function instances may also be analyzed.

An analytics clustering rule may group some of time series from a source into a group. Another analytics clustering rule may determine whether all time series in the set of input time series to an analytic function instance are members of a group, and if all time series in the set of input time series to the analytic function instance are members of the group, group an output time series of the analytic function instance in the group. Another analytics clustering rule may determine whether all time series in the set of input time series are members of a group, and group an output time series of the analytic function instance in a different group such that all members of the different group share a common input group configuration if all time series in the set of input time series are not members of a group.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an object graph in which the illustrative embodiments may be implemented;

FIG. 4 depicts a block diagram of analytic function instances and data sources scattered in a distributed data processing environment in which the illustrative embodiments may be implemented;

FIG. 5 depicts a block diagram of an analytics clustering application in accordance with an illustrative embodiment;

FIG. 6 depicts an object graph including analytic function instances in accordance with an illustrative embodiment;

FIG. 7 depicts a flowchart of a process of clustering analytic functions, time series, or both, in accordance with an illustrative embodiment;

FIG. 8 depicts a process of clustering time series in accordance with an illustrative embodiment;

FIG. 9 depicts another process of clustering time series in accordance with an illustrative embodiment; and

FIG. 10 depicts another process of clustering time series in accordance with an illustrative embodiment.

### DETAILED DESCRIPTION OF THE PREFERRED EMBODIMENT

The illustrative embodiments described herein provide a method, system, and computer usable program product for clustering analytic functions. The illustrative embodiments describe ways for distributing analytic functions instances in data processing environments, for example, where the number of elements and the number of analyses performed may be large. The illustrative embodiments further provide ways for clustering analytic function computations in such environments.

An element of a data processing environment, or a component of an element, is also known as a resource. When operating in a data processing environment, a resource may have one or more instances. An instance is a copy, an instance of a resource is a copy of the resource, and each instance of a resource is called an object. A resource type may have one or more instances, each representing an actual object, entity, thing, or a concept in the real world. A resource type is a resource of a certain type, classification, grouping, or characterization.

Additionally, a resource is a physical component of an environment, to wit, a physical manifestation of a thing in a given environment. In some embodiments, a resource is itself a physical thing. For example, a hard disk, a computer memory, a network cable, a router, a client computer, a network interface card, and a wireless communication device are each an example of a resource that is a physical thing. In some embodiments, a resource may be logical construct embodied in a physical thing. For example, a software application located on a hard disk, a computer instruction stored in a computer memory, data stored in a data storage device are each an example of a resource that is a logical construct embodied in a physical thing.

An object is generally a logical construct or a logical representation of a corresponding resource. In many embodiments, an object is a logical structure, a data construct, one or more computer instructions, a software application, a software component, or other similar manifestation of a resource. The logical manifestation of an object is used as an example when describing an object in this disclosure.

However, in some embodiments, an object may itself be a physical manifestation of a physical resource. For example, a compact disc containing a copy of a software application may be a physical object corresponding to a resource that may be a compact disc containing the software application. The illustrative embodiments described in this disclosure may be similarly applicable to physical objects in some cases.

An object may relate to other objects. For example, an actual router present in an actual data processing environment may be represented as an object. The router may have a set of interfaces, each interface being a distinct object. A set of interfaces is one or more interfaces. In this example setup, the router object is related to each interface object. In other words, the router object is said to have a relationship with an interface object.

An object graph is a conceptual representation of the objects and their relationships in any given environment at a given point in time. A point or node in the object graph represents an object, and an arc connecting two nodes represents a relationship between the objects represented by those nodes.

An object may be a data source. A data source is a source of some data. For example, an interface object related to a router object may be data source in that the interface object may provide data about a number of data packets passing through the interface during a specified period.

Objects, object relationships, and object graphs may be used in any context or environment. For example, a particular baseball player may be represented as an object, with a relationship with a different baseball player object in a baseball team object. Note that the baseball player object refers to an actual physical baseball player. Similarly, the baseball team object refers to an actual physical baseball team.

The first baseball player object may be source of data that may be that player's statistics. In other words, that player's statistics, for example, homeruns, is data that the player object—the data source—emits with some periodicity, such as after every game. The baseball team object may also be a data source, emitting team statistics data, which may be dependent on one or more player objects' data by virtue of the team object's relationship with the various player objects. Note that a characteristic of an object, such as emitting data or relating to other objects, refer to a corresponding characteristic of a physical resource in an actual environment that corresponds to the object.

Data emitted by a data source is also called a time series. In statistics, signal processing, and many other fields, a time series is a sequence of data points, measured typically at successive times, spaced according to uniform time intervals, other periodicity, or other triggers. An input time series is a time series that serves as input data. An output time series is a time series that is data produced from some processing. A time series may be an output time series of one object and an input time series of another object.

Time series analysis is a method of analyzing time series, for example to understand the underlying context of the data points, such as where they came from or what generated them. As another example, time series analysis may analyze a time series to make forecasts or predictions. Time series forecasting is the use of a model to forecast future events based on known past events, to wit, to forecast future data points before they are measured. An example in econometrics is the opening price of a share of stock based on the stock's past performance, which uses time series forecasting analytics.

Analytics is the science of data analysis. An analytic function is a computation performed in the course of an analysis. An analytic model is a computational model based on a set of analytic functions. As an example, a common application of analytics is the study of business data using statistical analysis, probability theory, operation research, or a combination thereof, in order to discover and understand historical patterns, and to predict and improve business performance in the future.

An analytic function specification is a code, pseudo-code, scheme, program, or procedure that describes an analytic function. An analytic function specification is also known as simply an analytic specification.

An analytic function instance is an instance of an analytic function, described by an analytic function specification, and executing in an environment. For example, two copies of a software application that implements an analytic function may be executing in different data processing systems in a data processing environment. Each copy of the software application would be an example of an analytic function instance.

As objects have relationships with other objects, analytic function instances can depend on one another. For example, one instance of a particular analytic function may use as an input time series, an output time series of an instance of another analytic function. The first analytic function instance is said to be depending on the second analytic function instance. Taking the baseball team example described above, an analytic function instance that analyzes a player object's statistics may produce the player object's statistics as an output time series. That output time series may serve as an input time series for a different analytic function instance that analyzes the team's statistics.

Furthermore, as an object graph represents the objects and their relationships, a dependency graph represents the relationships and dependencies among analytic function instances. The nodes in a dependency graph represent analytic function instances, and arcs connecting the nodes represent the dependencies between the nodes. Thus, by using a system of logical representations and computations, analytic functions and their instances analyze information and events that pertain to physical things in a given environment.

For example, with a stock market as an environment, analytic functions and their instances may analyze data pertaining to events relating to a real stock, which may be manifested as an identifier or a number in a physical system, or as a physical stock certificate.

Analytic functions may thus compute predictions about that stock. As another example, with a baseball league as an environment, analytic functions and their instances may analyze data pertaining to real players and real teams, which manifest as physical persons and organizations. Analytic functions may thus compute statistics about the real persons and organizations in the baseball league.

An analytic function may be instantiated in relation to a resource. Such a resource is called a “deployment resource”. An object corresponding to the deployment resource that has an analogous relationship with an analytic function instance of the analytic function is called a deployment object.

An analytic function may sample an input time series in several ways. Sampling a time series is reading, accepting, using, considering, or allowing ingress to a time series in the computation of the analytic function. An analytic function may sample an input time series periodically, such as by reading the input time series data points at a uniform interval. An analytic function may also sample an input time series by other trigger. For example, an analytic function may sample an input time series at every third occurrence of some event.

Furthermore, an analytic function may sample a time series based on a “window”. A window is a set of time series data points in sequence. For example, an analytic function may sample a time series in a window that covers all data points in the time series for the past one day. As another example, an analytic function may sample a time series in a window that covers all data points in the time series generated for the past thirty events.

Additionally, an analytic function may use a sliding window or a tumbling window for sampling a time series. A sliding window is a window where the span of the window remains the same but as the window is moved to include a new data point in the time series, the oldest data point in the time series in the previous coverage of the window falls off. A tumbling window is a window where the span of the window remains the same but as the window is moved to include a new set of data points in the time series, all the data points in the time series in the previous coverage of the window fall off.

For example, consider that a time series data points are 1, 2, 3, 4, 5, 6, 7, 8, 9, and 10. Also consider that an analytic function uses a window spanning three data points in this time series. At a given instance, the window may be so positioned that the analytic function samples the data points 4, 5, and 6. If the analytic function uses a sliding window, and slides the window one position, the analytic function will sample the data points 5, 6, and 7 in the time series. If the analytic function uses a tumbling window, the analytic function will sample data points 7, 8, and 9 in the time series.

Temporal semantics is a description in an analytic function specification describing how the analytic function samples a time series. Temporal semantics of an analytic function may include window description, including a span of the window and a method of moving the window, that the analytic function uses for sampling the time series.

An analytic function specification may specify a set of temporal semantics for the analytic function. A set of temporal semantics is one or more temporal semantics. For example, the analytic function may use different temporal semantic for different input time series. As another example, an analytic function may provide a user the option to select from a set of temporal semantics a temporal semantics of choice for sampling a time series.

Many implementations store the data points of time series and provide those stored time series to analytic function instances for analyzing after some time. Such a method of providing time series to analytic function instances is called a store and forward processing. Some implementations provide the data points of a time series to an analytic function instance as the data points are received where the analytic function instance may be executing. Such a method of providing time series to analytic function instances is called stream processing.

As described above, an object represents a resource that may be a physical thing in a given environment, and a characteristic of an object refers to a corresponding characteristic of a physical resource that corresponds to the object in an actual environment. Thus, by using a system of logical representations and computations, analytic functions analyze information and events that pertain to physical things in a given environment.

Illustrative embodiments recognize that present analytics techniques, whether using store and forward or stream processing method, are limited in flexibility. For example, a presently available analytic function is tailored to specific resources in specific relationship with each other in a specific situation in a data processing environment. Thus, the illustrative embodiments recognize that a present analytic function when deployed in a data processing environment does not lend itself to redeployment or replication in another part of the data processing environment where a similar set of inputs may be available for similar analysis.

In large data processing environments, or other environments, this rigidity of the method of design and deployment of analytic functions leads to multiple cycles of redevelopment, cloning, and cumbersome management of analytic functions, every time a new use for an existing analytic function is found. The illustrative embodiments recognize that the present method of deploying and managing analytic functions is wasteful, effort intensive, prone to errors, difficult to manage, and therefore undesirable.

The illustrative embodiments further recognize that environments with numerous resources may need analytics to be performed on data arriving from many different data sources. Furthermore, such analytics may have to be performed with minimal time delay between the origination of the data from a data source and the production of analytic results from executing an analytic function. As described above, the illustrative embodiments recognize that analytic functions may use multiple data sources organized in relationship hierarchies that can be complex. Analytic functions may themselves be in a hierarchy or be a part of exiting hierarchies, adding to the complexity.

Illustrative embodiments recognize that an analytic function using data sources and other analytic functions in this manner may sometimes have to wait for data to arrive at different speeds from different sources. On other occasions, in order to produce deterministic results, an analytic function may have to store some data, or use some stored data, in conjunction with later arriving data. In some other instances, analytic functions may have to be synchronized with certain data sources and other analytic functions to maintain the integrity and speed of the analytics.

To address these and other problems related to using analytic functions, the illustrative embodiments provide a method, system, and computer usable program product for clustering analytic functions. The illustrative embodiments are described using a data processing environment only as an example for the clarity of the description. The illustrative embodiments may be used in conjunction with any application or any environment that may use analytics, including but not limited to data processing environments.

For example, the illustrative embodiments may be implemented in conjunction with a manufacturing facility, sporting environment, financial and business processes, data processing environments, scientific and statistical computations, or any other environment where analytic functions may be used. The illustrative embodiments may also be implemented with any data network, business application, enterprise software, and middleware applications or platforms. The illustrative embodiments may be used in conjunction with a hardware component, such as in a firmware, as embedded software in a hardware device, or in any other suitable hardware or software form.

Any advantages listed herein are only examples and are not intended to be limiting on the illustrative embodiments. Additional advantages may be realized by specific illustrative embodiments. Furthermore, a particular illustrative embodiment may have some, all, or none of the advantages listed above.

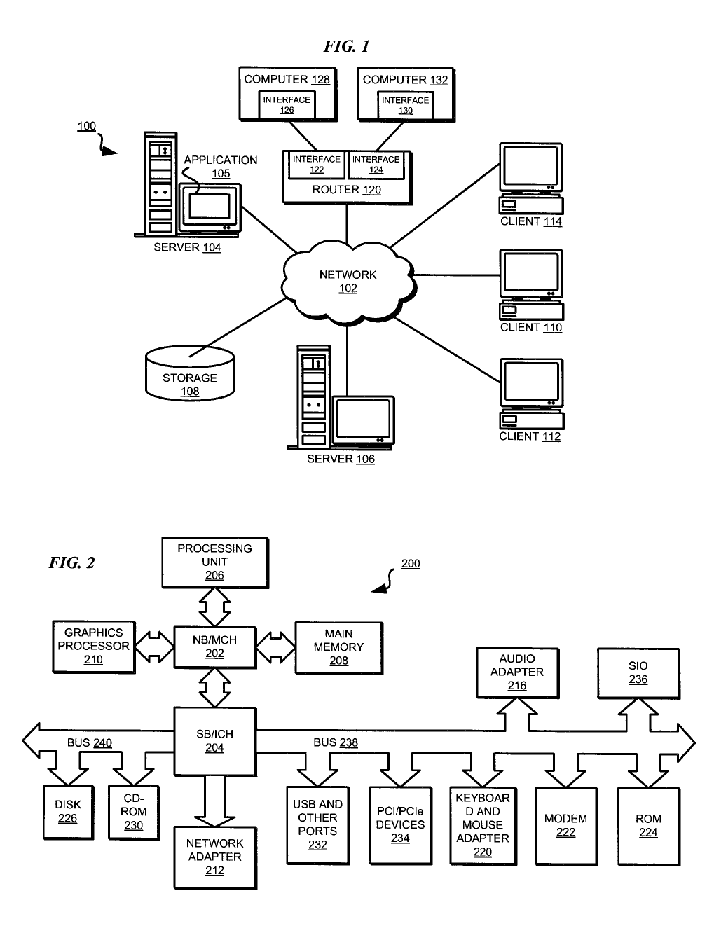

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108 that may include a storage medium.

Software applications may execute on any computer in data processing environment 100. In the depicted example, server 104 includes application 105, which may be an example of a software application, in conjunction with which the illustrative embodiments may be implemented. In addition, clients 112, and 114 couple to network 102. Client 110 may include application 111, which may engage in a data communication with application 105 over network 102, in context of which the illustrative embodiments may be deployed.

Router 120 may connect with network 102. Router 120 may use interfaces 122 and 124 to connect to other data processing systems. For example, interface 122 may use link 126, which is a communication pathway, to connect with interface 134 in computer 130. Similarly, interface 124 connects with interface 136 of computer 132 over link 128.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 provides data, such as boot files, operating system images, and applications to clients 110, 112, and 114. Clients 110, 112, and 114 are clients to server 104 in this example. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® XP (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

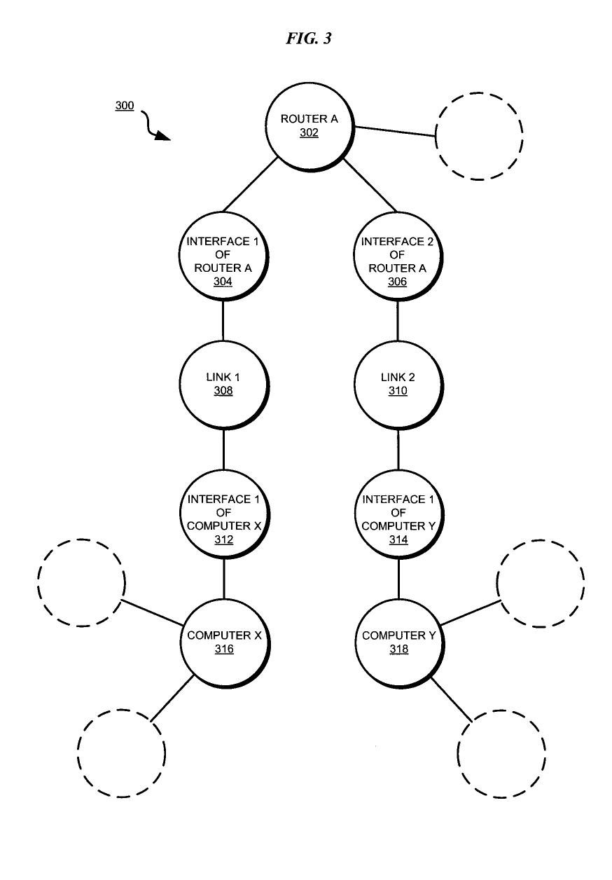

With reference to FIG. 3, this figure depicts an object graph in which the illustrative embodiments may be implemented. Object graph 300 may be implemented using a part of data processing environment 100 in FIG. 1. For example, in FIG. 1, servers 104 and 106, clients 110, 112, and 114, storage 108, and network 102 may be resources in data processing environments 100 that may be represented as objects in object graph 300. Each of these resources may include numerous components. Those components may in turn be objects related to the objects representing the resources. Router 120 may be another resource in data processing environment 100 that includes interfaces 122 and 124. Router 120 may be a resource that has relationships with interface 122 resource and interface 124 resource. Router 120 uses data links 126 and 128 to provide data communication services to computers 130 and 132.

In other words, an object representing interface 122 resource is related via an object representing link 126 resource to an object representing interface 134 resource, which is related to an object representing computer 130 resource. Similarly, an object representing interface 124 resource is related via an object representing link 128 resource to an object representing interface 136 resource, which is related to an object representing computer 132 resource. Recall that an object represents a resource that may be a physical thing in a given environment. Further recall that a characteristic of an object, such as emitting data or relating to other objects, refers to a corresponding characteristic of a physical resource in an actual environment that corresponds to the object.

In FIG. 3, object 302 labeled “router A” may be an object representation on object graph 300 of router 120 in FIG. 1. Objects 304 labeled “interface 1 of router A” and object 306 labeled “interface 2 of router A” may be objects representing interfaces 122 and 124 respectively in FIG. 1. Object 302 is related to objects 304 and 306 as depicted by the arcs connecting these objects. Object 302 may similarly be related to any number of other objects, for example, other interface objects similar to objects 304 and 306.

Object 308 labeled “link 1” may represent link 126 in FIG. 1. Object 310 labeled “link 2” may represent link 128 in FIG. 1. Object 312 labeled “interface 1 of computer X” may represent interface 134 in FIG. 1. Object 314 labeled “interface 1 of computer Y” may represent interface 136 in FIG. 1. Object 316 labeled “computer X” may represent computer 130 in FIG. 1. Object 318 labeled “computer Y” may represent computer 132 in FIG. 1. Objects 316 and 318 may similarly be related to any number of other objects, for example, other interface objects similar to objects 312 and 314 respectively.

Thus, object graph 300 represents an example actual data processing environment, example actual elements in that data processing environment, and example relationships among those elements. An object represented in object graph 300 may have any number of relationships with other objects within the scope of the illustrative embodiments.

Furthermore, any object in object graph 300 may act as a data source, emitting one or more time series. An object represents a resource in a given environment. An object emits a time series in an object graph if the resource emits the data points of the time series in the environment. Just as an object may emit one or more time series, an object may not emit any time series at all because a resource corresponding to the object may not emit any data. For example, one type of power supply may not emit any data but simply provide power in a data processing environment. Another type of power supply may include an administration application and emit monitoring data about the status of the power supply. Thus, an object corresponding to the first type of power supply resource may not emit a time series, whereas an object corresponding to the second type of power supply may emit a time series.

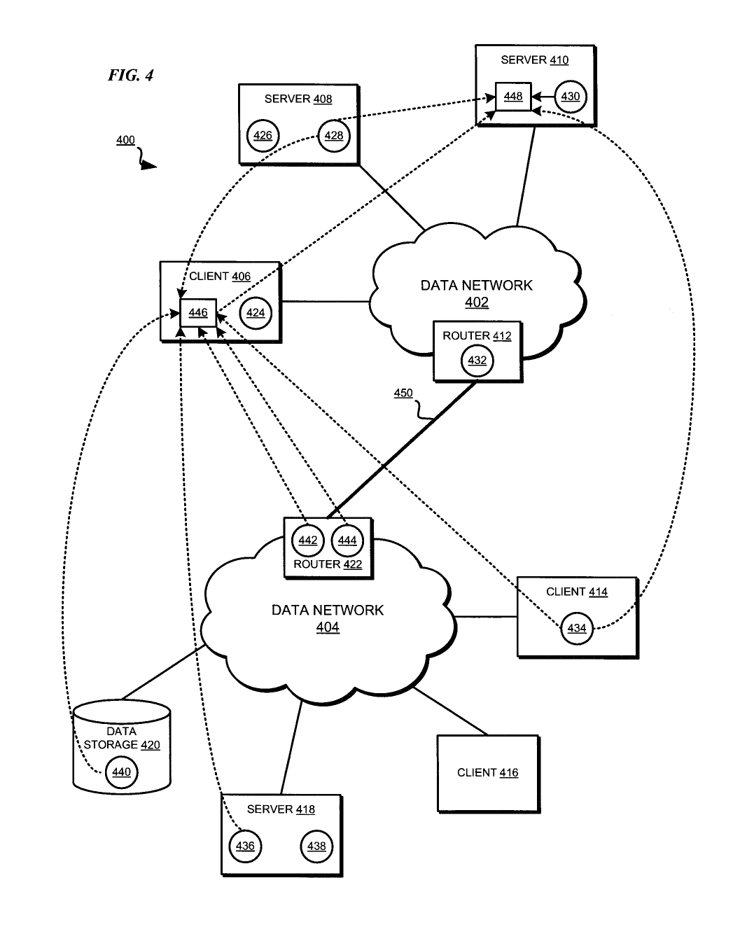

With reference to FIG. 4, this figure depicts a block diagram of analytic function instances and data sources scattered in a distributed data processing environment in which the illustrative embodiments may be implemented. Data processing environment 400 is an example data processing environment selected for the clarity of the description of the illustrative embodiments. Data processing environment 400 may be implemented using data processing environment 100 in FIG. 1. Data networks 402 and 404 may each be analogous to network 102 in FIG. 1.

Client 406, server 408, and server 410 may be data processing systems connected to data network 402. Router 412 may be a data routing device, such as a router, a hub, or a switch that may facilitate data communication to and from data network 402 to other networks, such as the internet or data network 404.

Client 414, client 416, server 418, and data storage device 420 may be data processing systems or components thereof connected to data network 404. Router 422 may be a data routing device, such as a router, a hub, or a switch that may facilitate data communication to and from data network 404 to other networks, such as the internet or data network 402.

A data processing system or a component of a data processing system may be an object or may have an object executing thereon, the object being a data source. For example, object 424 may be a software application component executing on client 406, emitting one or more time series. Objects 426 and 428 may be present at server 408 such that object 426 or object 428 may be server 408, an application component, or an application executing thereon and emitting time series. Similarly, object 430 may be present at server 410. Likewise, object 432 may be present at router 412. For example, object 432 may be a collector application executing on or communication with router 412, collecting raw data from router 412, and generating various time series.

Similarly, object 434 may be present at client 414, objects 436 and 438 may be present at server 418, and object 440 may be present at data storage device 420. Objects 442 and 444 may be present at router 422. Some or all of objects 434, 436, 438, 440, 442, 444 may generate one or more time series. Again, objects 442, object 444, or both, may be collector applications or other types of data sources.

Analytic function instance 446 may be an instance of an analytic function executing on client 406 as an example. Analytic function instance 448 may be another instance of an analytic function that may be same or different from the analytic function of analytic function instance 446. Analytic function instance 446 may receive one or more time series from one or more data sources scattered anywhere in data processing environment 400. As an example, analytic function instance 446 is shown to receive input time series from objects 428, 434, 436, 440, 442, and 444. Analytic function instance 448, also as an example, is shown to receive input time series from objects 428 and 434. Analytic function instance 448 also receives as an input time series an output time series of analytic function instance 446.

The example depiction in FIG. 4 shows that an analytic function instance may receive time series from objects that may be on other data processing systems than where the analytic function instance may be executing. FIG. 4 also shows that receiving input time series at an analytic function instance and sending output time series to other analytic function instances in this manner may increase data traffic across networks, such as over link 450.

Furthermore, by reasons of distance of a data source from an analytic function instance, intervening systems between the analytic function instance and a data source, or due to difference in periodicity of the various data sources, time series may arrive at an analytic function instance at different times or rates. A result of this situation, for example, may be that the computation at the analytic function instance may slow down while waiting for a slow or distant data source. Another example result of this situation may be that a network throughput may be adversely affected.

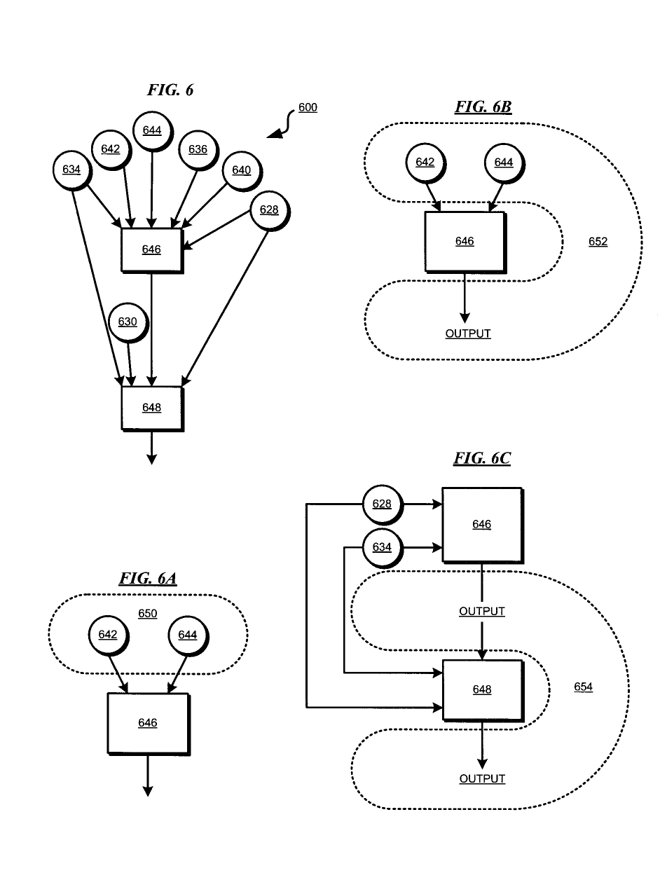

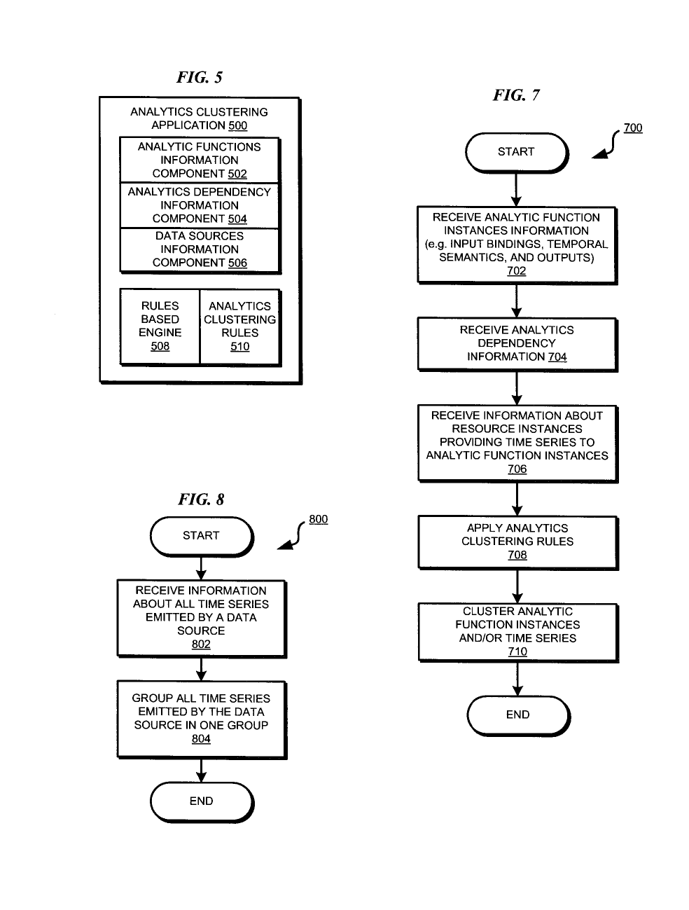

With reference to FIG. 5, this figure depicts a block diagram of an analytics clustering application in accordance with an illustrative embodiment. Analytics clustering application 500 may be implemented as a software application, such as application 105 in FIG. 1.

Analytics clustering application 500 includes analytic functions information component 502, which may collect and optionally store information about various analytic function instances in a given environment. For example, analytic functions information component 502 may collect information about the input bindings, temporal semantics, and location of execution of the various analytic function instances.

Analytics dependency information component 504 may identify, analyze, and optionally store information pertaining to dependencies of the various analytic function instances in the environment upon each other as well as other data sources. Data sources information component 506 may collect, analyze, and optionally store information about the various data sources in the environment. For example, data sources information component 506 may collect, analyze, and optionally store information about the periodicity of a time series emitted from a data source, the data source's location of execution in the environment, information about intervening systems, such as firewalls, to reach a data source, and any other type of information about a data source as may be relevant in a given environment.

Rules based engine 508 may be a component that processes analytics clustering rules 510. Analytics clustering rules 510 is a set of rules. A set of rules is one or more rules. A rule is a logic that determines an outcome given a set of inputs. A set of inputs is one or more inputs. A rule in analytics clustering rules 510 may, for example, accept a location of an analytic function instance and the locations of the data sources that provide input time series to the analytic function instance. The rule may then apply the logic encoded within the rule to determine if the analytic function instance can be relocated with respect to one or more of those data sources for a better performance of the analytic function instance's analytic function. As another example, another rule in analytics clustering rules 510 may determine whether certain input time series may be grouped together so that two analytic function instances with similar input series from that group of input time series may generate their respective output time series in a substantially synchronized manner.

The rules described above are only described as examples and are not intended to be limiting on the illustrative embodiments. Many rules can similarly be created for clustering and distributing analytic function instances, and clustering or grouping time series in a given environment. FIGS. 6A, 6B, 6C, and 6D provide some more examples of analytics clustering rules 510.

With reference to FIG. 6, this figure depicts an object graph including analytic function instances in accordance with an illustrative embodiment. Object graph 600 may represent environment 400 in FIG. 4. For example, Objects 628, 630, 634, 636, 640, 642, and 644 may correspond to objects 428, 430, 434, 436, 440, 442, and 444 respectively in FIG. 4. Similarly, analytic function instances 646 and 648 may correspond to analytic function instances 446 and 448 respectively in FIG. 4.

Objects 628, 634, 636, 640, 642, and 644 provide input time series to analytic function instance 646. Analytic function instance 648 receives input time series from objects 628, 630, 634, and analytic function instance 646.

Objects, such as for example, objects 628 and 634, may generate more than one time series. In one embodiment, objects 628 and 634 may provide different time series to analytic function instances 646 and 648. In one embodiment, objects 628 and 634 may provide the same time series to analytic function instances 646 and 648.

Thus, object 646, an example analytic function instance, may analyze data from resources having a physical manifestation in a real environment. As depicted in the example environment of FIG. 4, analytic function of object 646 analyzes data that may originate from two network interfaces in a router, a software application executing in a client, two separate application components executing in two separate servers, and a data storage device. Notice that each of these sources of data is either a physical thing or a thing that has is identifiable to a physical thing in the environment of FIG. 4.

The input time series and the relationship between the various objects and analytic function instances in FIG. 4 is depicted only as an example and is not intended to be limiting on the illustrative embodiments. An analytic function instance may receive output time series from a combination of one or more analytic function instances and one or more objects. Furthermore, an analytic function instance, such as analytic function instance 646 or 648 may be instantiated in relation to an object that may or may not be depicted in object graph 600. For example, in one embodiment, analytic function instance 646 may be instantiated in relation with object 642 and receive a time series from object 642. In another embodiment, analytic function instance 646 may be instantiated in relation to an object not depicted in FIG. 6 but receive time series as depicted in FIG. 6. Other combinations of objects having relationships with analytic function instances are contemplated within the scope of the illustrative embodiments.

With reference to FIG. 6A, this figure depicts a grouping of time series according to a logic in an example analytics clustering rule in accordance with an illustrative embodiment. FIG. 6A depicts a partial object graph from object graph 600 in FIG. 6 to illustrate the analytics clustering rule. Objects 642 and 644 in FIG. 6A are the same as objects 642 and 644 in FIG. 6. Analytic function instance 646 is the same as analytic function instance 646 in FIG. 6.

An analytics clustering rule, such as one of analytics clustering rules 510 in FIG. 5, may include logic that may assign various time series emitted by a common data source into a common group. Group 650 represents a group of which time series from objects 642 and 644 are members.

Note that objects 642 and 644 correspond to objects 442 and 444 executing in router 422 in FIG. 4. A data source may be represented as a single or multiple objects. Conversely, an object may represent single or multiple data sources, for example, when emitting multiple time series. In the example of FIG. 6A, objects 642 and 644 may represent a common data source and time series emitting from objects 642 and 644 may therefore be grouped together in group 650 according to an example analytics clustering rule.

In one embodiment, the logic in such an analytics clustering rule may reflect the expectation that time series from a common data source may have similar periodicities. In another embodiment, the logic may reflect an expectation that time series from a common data source may arrive at a destination with similar delays. The logic may represent another expectation in grouping time series from a common data source into a common group without departing from the scope of the illustrative embodiments.

With reference to FIG. 6B, this figure depicts a grouping of time series according to a logic in another example analytics clustering rule in accordance with an illustrative embodiment. FIG. 6B depicts a partial object graph from object graph 600 in FIG. 6 to illustrate the analytics clustering rule. Objects 642 and 644 in FIG. 6B are the same as objects 642 and 644 in FIG. 6. Analytic function instance 646 is the same as analytic function instance 646 in FIG. 6.

An analytics clustering rule, such as one of analytics clustering rules 510 in FIG. 5, may include logic that may determine that if all input time series to an analytic function instance share a common group, the output time series of the analytic function instance is also assigned to the same group. Group 652 represents a group of which input time series from objects 642 and 644 and output time series from analytic function instance 646 are members.

Note that objects 642 and 644 can be grouped in a common group according the example analytics clustering rule in FIG. 6A. Thus, the time series from objects 642 and 644, and the output time series of analytic function instance 646 are grouped into group 652 according to the rule in FIG. 6B.

In one embodiment, the logic in such an analytics clustering rule may reflect the expectation that input time series from a common data source may have similar periodicities, causing an output time series dependent on those input time series to have substantially similar periodicity. In another embodiment, the logic may reflect an expectation that objects generating time series with similar periodicity may be co-located, to wit, situated in a common, close, or proximate data processing system. The logic may represent another expectation in grouping time series from a common data source into a common group without departing from the scope of the illustrative embodiments.

With reference to FIG. 6C, this figure depicts a grouping of time series according to a logic in another example analytics clustering rule in accordance with an illustrative embodiment. FIG. 6C depicts a partial object graph from object graph 600 in FIG. 6 to illustrate the analytics clustering rule. Objects 628 and 634 in FIG. 6C are the same as objects 628 and 634 in FIG. 6. Analytic function instances 646 and 648 are the same as analytic function instances 646 and 648 in FIG. 6.

An analytics clustering rule, such as one of analytics clustering rules 510 in FIG. 5, may include logic that may determine that if the input time series to an analytic function instance are emitted by a data source external to the system where the analytic function instance may be executing, the output time series of the analytic function instance is assigned to a group whose other members share the same input time series configuration. Group 654 represents a group of which output time series from analytic function instances 646 and 648 are members because both output time series share the common input series configuration. In other words, both input time series to analytic function instance 646 and analytic function instance 648 originate at a resource other than the resource on which analytic function instance 646 and analytic function instance 648 are executing. Additionally both output time series result from same or different analytics performed using the same two input time series.

Thus, each output time series is a result of input time series in similar configuration at each of analytic function instance 646 and analytic function instance 648. Consequently, the analytics clustering rule depicted in FIG. 6C clusters the output time series from analytic function instances 646 and 648 into group 654.

In one embodiment, the logic in such an analytics clustering rule may reflect the expectation that output time series generated from a common configuration of input time series may have similar periodicities. The logic may represent another expectation in grouping time series from a common data source into a common group without departing from the scope of the illustrative embodiments.

With reference to FIG. 7, this figure depicts a flowchart of a process of clustering analytic functions, time series, or both, in accordance with an illustrative embodiment. Process 700 may be implemented using analytics clustering application 500 in FIG. 5.

Process 700 begins by receiving information about the various analytic function instances executing in an environment (step 702). For example, process 700 may collect information regarding the input bindings, temporal semantics, output time series, deployment objects, location of execution, and other characteristics of an analytic function instance in step 702.

Process 700 receives information about dependencies existing between the various analytic function instances (step 704). For example, process 700 may analyze an object graph to determine which analytic function instance depends on which other one or more analytic function instances for inputs. In other words, process 700 may analyze the object graph to determine if an analytic function instance uses as an input time series, an output time series from one or more analytic function instances, and their relative locations of executions in step 704.

Process 700 may also receive information about the various resources and objects that may be providing input time series to one or more analytic function instances in the environment (step 706). Process 700 may execute an analytics clustering rule using the information collected in steps 702, 704 and 706 (step 708).

Process 700 may cluster the analytic function instances, the various input and output time series, or both, according to the analytics clustering rule (step 710). Process 700 ends thereafter.

With reference to FIG. 8, this figure depicts a process of clustering time series in accordance with an illustrative embodiment. Process 800 may be implemented in an analytics clustering rule, such as a rule in analytics clustering rules 510 in FIG. 5. Execution of process 800 may result in a grouping 650 as depicted in FIG. 6A.

Process 800 begins by receiving information about all time series emitted by a data source, such as from one or more objects (step 802). Process 800 groups all time series emitted by a common data source into a single group (step 804). Process 800 ends thereafter.

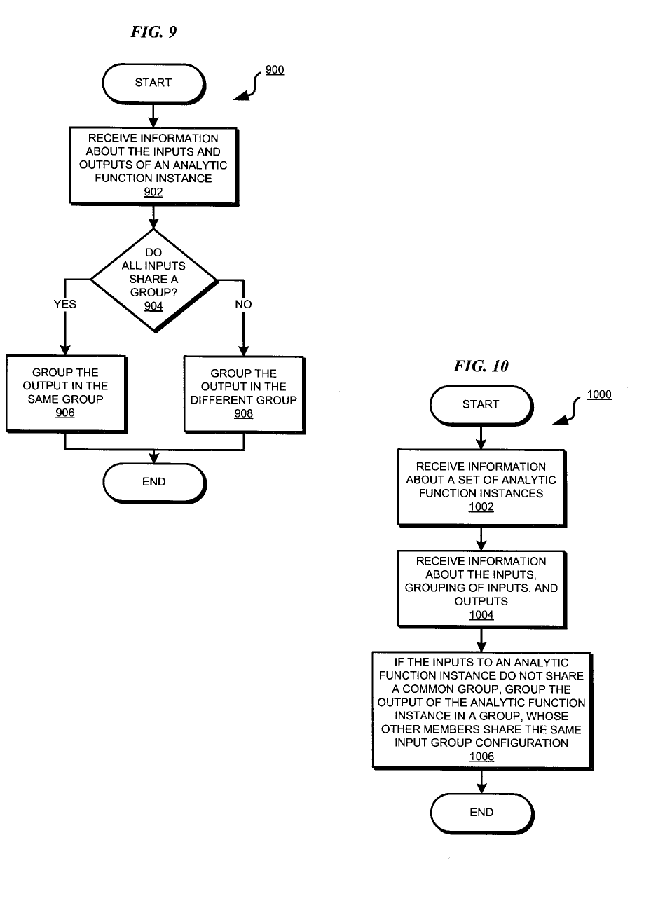

With reference to FIG. 9, this figure depicts another process of clustering time series in accordance with an illustrative embodiment. Process 900 may be implemented in an analytics clustering rule, such as a rule in analytics clustering rules 510 in FIG. 5. Execution of process 900 may result in a grouping 652 as depicted in FIG. 6B.

Process 900 begins by receiving information about all inputs and outputs, such as input and output time series, of an analytic function instance (step 902). Process 900 analyzes if all the inputs to an analytic function instance share a group (step 904). If process 900 determines that all inputs to an analytic function instance share a group (“Yes” path of step 904), process 900 groups an output of the analytic function instance in the same group that the inputs share (step 906).

If process 900 determines that all inputs to an analytic function instance do not share a group (“No” path of step 904), process 900 may group an output of the analytic function instance in a different group than the inputs (step 908). Process 900 ends thereafter.

With reference to FIG. 10, this figure depicts another process of clustering time series in accordance with an illustrative embodiment. Process 1000 may be implemented in an analytics clustering rule, such as a rule in analytics clustering rules 510 in FIG. 5. Execution of process 1000 may result in a grouping 654 as depicted in FIG. 6C.

Process 1000 begins by receiving information about a set of analytic function instances (step 1002). A set of analytic function instances is one or more analytic function instances. Process 1000 further receives information about the various inputs to the various analytic function instances, groupings of those inputs, and outputs of those analytic function instances (step 1004). Process 1000 groups an output of an analytic function instance in a group whose members share an input group configuration similar to the input group configuration related to the output (step 1006). Process 1000 ends thereafter.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for clustering analytic functions. An object represents a resource that may be a physical thing in a given environment, and a characteristic of an object refers to a corresponding characteristic of a physical resource that corresponds to the object in an actual environment. Thus, by using a system of logical representations and computations, analytic functions analyze information and events that pertain to physical things in a given environment.

A user or a deployment process may cluster analytic function instances by grouping the analytic function instances or the various time series in an environment. The analytic function instances, the input and output time series, the input bindings including the deployment object of an analytic function instance, and other characteristics of analytic function instances are used for clustering the analytic function instances and the time series.

The illustrative embodiments may be used to cluster analytic function instances in such a way that reduces data traffic in a network. For example, an analytic function instance may be located close to a data source such that the data from the data source may travel only a short distance to an analytic function instance as compared to when the analytic function instance is located far from the data source. In one embodiment, being located on the same data processing system may be sufficient for being located close. In another embodiment, being located on the same local area network (LAN) may be sufficient for being located close. In yet another embodiment, being located within an environment of a business organization may be sufficient for being located close.

The illustrative embodiments may be further used to cluster time series such that the periodicity, delay, slew, distance, or another characteristic of the clustered time series are substantially similar to one another. For example, two data inputs arriving from a remote server across a firewall may experience similar network delays in arriving to an analytic function instance. Thus, the data inputs may be clustered together according to the illustrative embodiments.

Using the illustrative embodiments for clustering input and output time series of analytic function instances in this manner, a user or process may be able to synchronize the various time series in a manner that minimizes the buffering of data. For example, in clustering time series according to the illustrative embodiments, a system may not have to store data from one input time series while waiting for a different input time series. Time series in a cluster may all arrive approximately together thereby reducing the amount of data that has to be buffered from a the time series without the benefit of the illustrative embodiments.

Analytic function clustering and time series clustering according to the illustrative embodiments may change based on changes in the resources in an environment. Processes according to the illustrative embodiments may allow a user or a process to cluster analytic function instances differently in different object graphs. Similarly, processes according to the illustrative embodiments may allow a user or a process to cluster a time series differently in different object graphs.

Furthermore, the illustrative embodiments may be practiced in conjunction with environments where input time series are stored and forwarded to analytic functions. The illustrative embodiments may also be practiced in conjunction with environments where input time series are stream processed by the analytic functions.

The illustrative embodiments may be used in conjunction with any application or any environment that may use analytics. An example of such environments where the illustrative embodiments are applicable is a data processing environment, such as where a number of data processing systems, computing devices, communication devices, data networks, and components thereof may be in communication with each other. As another example, the illustrative embodiments may be implemented in conjunction with financial and business processes, such as where a number of persons, devices, or instruments may generate reports, catalogs, trends, factors, or values that have to be analyzed in a dynamic or changing environment.

As another example, the illustrative embodiments may be implemented in scientific and statistical computation environments, such as where a number of data processing systems, devices, or instruments may produce data that has to be analyzed in an unpredictable or dynamic environment. As another example, the illustrative embodiments may be implemented in a manufacturing facility where equipment, gadgets, systems, and personnel may produce products and information related to products in a flexible or dynamic environment.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for clustering analytic functions, the computer implemented method comprising:
receiving information about a set of analytic function instances;
receiving information about a set of time series, the set of time series comprising data produced by a set of physical components in an environment, a first subset of the set of time series being a set of input time series received over a data network in an analytic function instance in the set of analytic function instances;
applying an analytics clustering rule to the information about the set of analytic function instances and the information about the set of time series; and
clustering a second subset of time series in a group responsive to applying the analytics clustering rule.

2. The computer implemented method of claim 1, wherein receiving the information about the set of analytic function instances further comprises:
receiving an information about an input binding of the analytic function instance;
receiving information about a temporal semantics of the analytic function instance; and
receiving information about an output time series of the analytic function instance, wherein the output time series comprises data produced by the analytic function instance.

3. The computer implemented method of claim 1, wherein receiving the information about the set of time series further comprises:
receiving information about a source of a time series in the set of time series, the information about the source including information about a location of the source, wherein the source corresponds to a physical component of the environment; and
receiving information about one of (i) a periodicity and (ii) a delay of the time series in the set of time series.

4. The computer implemented method of claim 3, wherein an output time series of the analytic function instance is a time series in the set of time series, and wherein the output time series comprises data produced by the analytic function instance.

5. The computer implemented method of claim 1, further comprising:
analyzing a dependency between a first analytic function instance and a second analytic function instance in the set of analytic function instances.

6. The computer implemented method of claim 1, wherein the analytics clustering rule comprises:
grouping a plurality of time series from a source into a group, wherein the source corresponds to a physical component of the environment.

7. The computer implemented method of claim 1, wherein the analytics clustering rule comprises:
determining, forming a grouping determination, whether all time series in the set of input time series are members of a group; and
grouping, responsive to the grouping determination being true, an output time series of the analytic function instance in the group, wherein the output time series comprises data produced by the analytic function instance.

8. The computer implemented method of claim 1, wherein the analytics clustering rule comprises:
determining, forming a grouping determination, whether all time series in the set of input time series are members of a group; and
grouping, responsive to the grouping determination being false, an output time series of the analytic function instance in a second group, wherein all members of the second group share a common input group configuration, and wherein the output time series comprises data produced by the analytic function instance.

9. A computer implemented method for clustering analytic functions, the computer implemented method comprising:
receiving information about a set of analytic function instances;
receiving information about a set of time series, the set of time series comprising data produced by a set of physical components in an environment, a physical component being a data source, a time series in the set of time series being associated with a data source in a set of data sources, and a first subset of the set of time series being a set of input time series received over a data network in an analytic function instance in the set of analytic function instances;
applying an analytics clustering rule to the information about the set of analytic function instances and the information about the set of time series; and
co-locating, in a data processing system, the analytic function instance and a subset of data sources in the set of data sources responsive to applying the analytics clustering rule.

10. The computer implemented method of claim 9, wherein receiving the information about the set of analytic function instances further comprises:
receiving an information about an input binding of the analytic function instance;
receiving information about a temporal semantics of the analytic function instance; and
receiving information about an output time series of the analytic function instance, wherein the output time series comprises data produced by the analytic function instance; and
wherein receiving the information about the set of time series further comprises:
receiving information about a source of a time series in the set of time series, the information about the source including information about a location of the source, wherein the source corresponds to a physical component of the environment; and
receiving information about one of (i) a periodicity and (ii) a delay of the time series in the set of time series.

11. The computer implemented method of claim 9, wherein a second analytic function instance in the set of analytic function instances corresponds to a data source in the set of data sources, and wherein an output time series of the second analytic function instance is a time series in the set of time series, and wherein the output time series comprises data produced by the analytic function instance.

12. The computer implemented method of claim 11, further comprising:
analyzing a dependency between the analytic function instance and the second analytic function instance.

13. The computer implemented method of claim 9, wherein the analytics clustering rule comprises:
determining, forming a co-location determination, if co-locating the analytic function instance and the subset of data sources reduces a data traffic in the data network; and
grouping the analytic function instance and the subset of data sources in a group, responsive to the co-location determination being true.

14. A computer usable program product comprising a computer usable medium including computer usable code for clustering analytic functions, the computer usable code comprising:
computer usable code for receiving information about a set of analytic function instances;
computer usable code for receiving information about a set of time series, the set of time series comprising data produced by a set of physical components in an environment, a first subset of the set of time series being a set of input time series received over a data network in an analytic function instance in the set of analytic function instances;
computer usable code for analyzing a dependency between the analytic function instance and a second analytic function instance in the set of analytic function instances;
computer usable code for applying an analytics clustering rule to the information about the set of analytic function instances and the information about the set of time series; and
computer usable code for clustering a second subset of time series in a group responsive to applying the analytics clustering rule.

15. The computer usable program product of claim 14, wherein the computer usable code for receiving the information about the set of analytic function instances further comprises:
computer usable code for receiving an information about an input binding of the analytic function instance;
computer usable code for receiving information about a temporal semantics of the analytic function instance; and
computer usable code for receiving information about an output time series of the analytic function instance, wherein the output time series comprises data produced by the analytic function instance; and
wherein the computer usable code for receiving the information about the set of time series further comprises:
computer usable code for receiving information about a source of a time series in the set of time series, the information about the source including information about a location of the source, wherein the source corresponds to a physical component of the environment; and
computer usable code for receiving information about one of (i) a periodicity and (ii) a delay of the time series in the set of time series.

16. The computer usable program product of claim 14, wherein an output time series of the analytic function instance is a time series in the set of time series, and wherein the output time series comprises data produced by the analytic function instance.

17. The computer usable program product of claim 14, wherein the analytics clustering rule comprises:
computer usable code for grouping a plurality of time series from a source into a group, wherein the source corresponds to a physical component of the environment.

18. The computer usable program product of claim 14, wherein the analytics clustering rule comprises:
computer usable code for determining, forming a grouping determination, whether all time series in the set of input time series are members of a group; and
computer usable code for grouping, responsive to the grouping determination being true, an output time series of the analytic function instance in the group, wherein the output time series comprises data produced by the analytic function instance.

19. The computer usable program product of claim 14, wherein the analytics clustering rule comprises:
computer usable code for determining, forming a grouping determination, whether all time series in the set of input time series are members of a group; and
computer usable code for grouping, responsive to the grouping determination being false, an output time series of the analytic function instance in a second group, wherein all members of the second group share a common input group configuration, and wherein the output time series comprises data produced by the analytic function instance.

20. A data processing system for clustering analytic functions, the data processing system comprising:
a storage device including a storage medium, wherein the storage device stores computer usable program code; and
a processor, wherein the processor executes the computer usable program code, and wherein the computer usable program code comprises:
computer usable code for receiving information about a set of analytic function instances;
computer usable code for receiving information about a set of time series, the set of time series comprising data produced by a set of physical components in an environment, a first subset of the set of time series being a set of input time series received over a data network in an analytic function instance in the set of analytic function instances;
computer usable code for analyzing a dependency between the analytic function instance and a second analytic function instance in the set of analytic function instances;
computer usable code for applying an analytics clustering rule to the information about the set of analytic function instances and the information about the set of time series; and
computer usable code for clustering a second subset of time series in a group responsive to applying the analytics clustering rule.

21. The computer usable program product of claim 20, wherein the computer usable code for receiving the information about the set of analytic function instances further comprises:
computer usable code for receiving an information about an input binding of the analytic function instance;
computer usable code for receiving information about a temporal semantics of the analytic function instance; and
computer usable code for receiving information about an output time series of the analytic function instance, wherein the output time series comprises data produced by the analytic function instance; and
wherein the computer usable code for receiving the information about the set of time series further comprises:
computer usable code for receiving information about a source of a time series in the set of time series, the information about the source including information about a location of the source, wherein the source corresponds to a physical component of the environment; and
computer usable code for receiving information about one of (i) a periodicity and (ii) a delay of the time series in the set of time series.

22. The computer usable program product of claim 20, wherein an output time series of the analytic function instance is a time series in the set of time series, and wherein the output time series comprises data produced by the analytic function instance.

23. The computer usable program product of claim 20, wherein the analytics clustering rule comprises:
computer usable code for grouping a plurality of time series from a source into a group, wherein the source corresponds to a physical component of the environment.

24. The computer usable program product of claim 20, wherein the analytics clustering rule comprises:
computer usable code for determining, forming a grouping determination, whether all time series in the set of input time series are members of a group; and
computer usable code for grouping, responsive to the grouping determination being true, an output time series of the analytic function instance in the group, wherein the output time series comprises data produced by the analytic function instance.

25. The computer usable program product of claim 20, wherein the analytics clustering rule comprises:
computer usable code for determining, forming a grouping determination, whether all time series in the set of input time series are members of a group; and
computer usable code for grouping, responsive to the grouping determination being false, an output time series of the analytic function instance in a second group, wherein all members of the second group share a common input group configuration, and wherein the output time series comprises data produced by the analytic function instance.
